(19) United States
(12) Patent Application Publication
(10) Pub. No.: US 2020/0201357 A1
(43) Pub. Date: Jun. 25, 2020

(54) SYSTEMS AND METHODS FOR VEHICLE SCHEDULING AND ROUTING

(71) Applicant: Ford Global Technologies, LLC, Dearborn, MI (US)

(72) Inventors: Xiangrui Zeng, Northville, MI (US); Amit Mohanty, Canton, MI (US); Arnold Babila, Ann Arbor, MI (US)

(73) Assignee: Ford Global Technologies, LLC, Dearborn, MI (US)

(21) Appl. No.: 16/230,525

(22) Filed: Dec. 21, 2018

(51) Int. Cl. G05D 1/02; G08G 1/01; G08G 1/052; G08G 1/00; G01C 21/34

(52) U.S. Cl. CPC G05D 1/0297; G08G 1/0145; G08G 1/0112; G05D 2201/0213; G08G 1/20; G01C 21/3469; G08G 1/052

(57) ABSTRACT

Systems, methods, and computer-readable media are disclosed for optimizing vehicle scheduling in routes for fleet management. Example methods may include determining traffic data associated with one or more routes for at least one first vehicle of a fleet and determining one or more parameters from the traffic data; performing at least one first artificial intelligence (AI)-based algorithm using the one or more parameters to determine a social travel time associated with one or more second vehicles; and performing at least one second AI-based algorithm based at least in part on the social travel time to determine one or more impact parameters.

### TECHNICAL FIELD

The present disclosure relates to systems, methods, and computer-readable media for vehicle schedule and routing.

### BACKGROUND

Traffic congestion represents a growing problem for many cities and municipalities around the world. Traffic congestion may result in wasted time, additional energy consumption and pollution resulting from excessive vehicle emission. In another aspect, traffic flow may have temporal asymmetries in that there may be a large number of vehicles on the road during rush hours, and much lower number of vehicles in non-rush hours.

### BRIEF DESCRIPTION OF THE DRAWINGS

FIG. 1 shows a block diagram of an example, non-limiting system for fleet management, in accordance with one or more embodiments described herein.

FIG. 2A shows a diagram of a platform framework, in accordance with example embodiments of the disclosure.

FIG. 2B shows a diagram of an algorithm workflow, in accordance with example embodiments of the disclosure.

FIG. 3 provides a schematic of several computing entities, according to example embodiments of the disclosure.

FIG. 4 shows an illustrative schematic representative of a user device that can be used in conjunction with example embodiments of the disclosure.

FIG. 5 shows a plot of a speed-density diagram, in accordance with example embodiments of the disclosure. Treiber M, Kesting A. Traffic flow dynamics. Traffic Flow Dynamics: Data, Models and Simulation, Springer-Verlag Berlin Heidelberg. 2013.

FIG. 6 shows a diagram of a plot representative travel time and marginal social travel time associated with and under various operation schedules, in accordance with example embodiments of the disclosure.

FIG. 7 shows a diagram of another plot representative travel time and marginal social travel time associated with and under various operation schedules, in accordance with example embodiments of the disclosure.

FIG. 8 shows a diagram of an example flow for implementing aspects of fleet management, in accordance with example embodiments of the disclosure.

FIG. 9 shows an illustration of an example server architecture for one or more server(s), in accordance with example embodiments of the disclosure.

FIG. 10 shows a diagram of a cloud-computing environment that may be used in connection with example embodiments of the disclosure

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In various aspects, traffic flow may have temporal asymmetries in that there may be a large number of vehicles on the road during rush hours, and much lower number of vehicles in non-rush hours. In particular, for fleets of vehicles (hereinafter also referred to simply as fleets) that run on non-time-sensitive tasks, shifting driving times to earlier or later times to avoid the rush hour traffic can save time, save fuel, and reduce the risk of accidents. Moreover, various entities such as city governments may seek to promote re-scheduling of fleet operation times in order to reduce rush hour traffic and simultaneously reduce emissions as well as accidents.

In various embodiments, while the reduction of traffic resulting from the rescheduling of one vehicle or one fleet of vehicles to avoid rush hour may be difficult to observe at the macroscopic level (e.g., traffic flow level) for a given environment (e.g., a city), benefits can be observable at the microscopic level (e.g., single vehicle level). Accordingly, there may be various benefits in re-scheduling fleets, both for the fleets themselves and the environment (e.g., city) that they are deployed.

In various embodiments, rescheduling a fleet's operational schedule may affect many parameters related to the fleet. For example, there may be costs in terms of the inconvenience and potential financial losses to users (e.g., vehicle drivers and/or customers). In contrast, the benefit of rescheduling may be unclear to users (e.g., fleet managers, governing entities, drivers, and/or customers), at least because realized benefits may be dependent on several factors including, but not limited to, the fleet's current schedule, routes, road infrastructures, traffic conditions, combinations thereof, and/or the like. Accordingly, without computational tools and mobility data support, fleet scheduling may be performed in a trial-and-error technique, which may incur various associated costs and may take a large amount of time. Further, despite the efforts, manual scheduling may nevertheless be sub-optimal, for example, due at least to a limited number of trails observed and analyzed, and due to noisy data.

Additionally, there may exist various logistical and/or navigational tools that may serve to provide travel time estimation for fleet scheduling purposes. However, such logistical and/or navigational tools may not be able to evaluate other tangential benefits of fleet schedule optimization, for example, quantifiable benefits in terms of energy savings and/or accident risk reduction metrics for a given area. Moreover, such tools may not be able to evaluate the impact of fleet re-scheduling on the environment in which the fleet operates, for example, a city in which the fleet operates. In another aspect, for a relatively large environment such as a city, the benefit of operation rescheduling may depend on various factors that are described herein. Further, it may be difficult to observe relatively subtle changes to various parameters of interest including, but not limited to, macro-level traffic, emission, and/or accident data if only a small number of vehicles (e.g., the number of vehicles in the fleet) adjust their schedules. Moreover, such macro-level benefits may not only result from re-scheduled vehicles of a fleet, but may also come from other vehicles in the environment which may thereby run more smoothly as rush hour traffic is reduced and roads become less congested.

In various aspects, there may not be clear communication channels between users such as a governing entity (e.g., a city) and fleet operators, which may make it difficult for the governing entity and the fleet operators to cooperatively determine fleet schedules. In various embodiments, by using mobility big data and by building artificial intelligence (AI)-based analytics algorithms as described herein, communication channels may be generated to serve fleet operators governing entities.

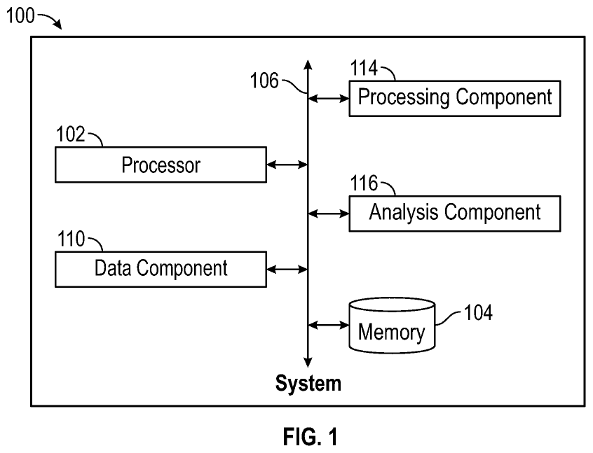

FIG. 1 shows a block diagram of an example, non-limiting system for fleet management, in accordance with one or more embodiments described herein. Aspects of systems (e.g., system 100 and the like), apparatuses, and/or processes described in this disclosure can constitute machine-executable component(s) embodied within machine(s), e.g., embodied in one or more computer readable mediums (or media) associated with one or more machines. Such component(s), when executed by the one or more machines, e.g., computer(s), computing device(s), virtual machine(s), etc. can cause the machine(s) to perform the operations described.

System 100 can optionally include a server device, one or more networks, and one or more devices (not shown). The system 100 can also include or otherwise be associated with at least one processor 102 that executes computer executable components stored in memory 104. The system 100 can further include a system bus 106 that can couple various components including, but not limited to, a data component 110, a processing component 114, and an analysis component 116. The system 100 can be any suitable computing device or set of computing devices that can be communicatively coupled to devices, non-limiting examples of which can include, but are not limited to, a server computer, a computer, a mobile computer, a mainframe computer, an automated testing system, a network storage device, a communication device, a web server device, a network switching device, a network routing device, a gateway device, a network hub device, a network bridge device, a control system, or any other suitable computing device. A device can be any device that can communicate information with the system 100 and/or any other suitable device that can employ information provided by system 100. It is to be appreciated that system 100, components, models or devices can be equipped with a communication component (not shown) that enable communication between the system, components, models, devices, etc. over one or more networks.

As noted, embodiments of the disclosure are directed to fleet operation schedule optimization using mobility data and AI-based analytic algorithms to quantify the impact of vehicle operation rescheduling on fleet operations and corresponding environments (e.g., cities). Further embodiments are directed to providing means for fleet operators and governing entities to adjust vehicle operation schedules to achieve optimal traffic flow in the environment of interest.

In one aspect, embodiments of the disclosure a data component 110 may use one or more types of data including, but not limited to, road map data, historical traffic speed data, road speed-density data, fleet telematics data, traffic density data, emission data, and traffic accident data, combinations thereof, and/or the like. In another embodiment, a processing component 114 may use AI-based analytic algorithms that may be configured to calculate a marginal social travel time cost (to be described further below) to a plurality of on-road vehicles when one more vehicle is added to a given route. In one embodiment, the marginal social travel time can be correlated to various environment parameters (e.g., city traffic congestion, emission, and accident rate changes) due to fleet rescheduling. Accordingly, any analysis component 116 in communication with the processing component 114 may determine the fleet-level re-scheduling impact on additional parameters including, but not limited to, labor time, energy costs, risk of accidents, and the like, which may be modeled and calculated. In another embodiment, the determined information may be presented to one or more users (e.g., city governing entities and fleet operations managers) to provide a communication channel to cooperatively optimize the operational schedules of a given group of vehicles (e.g., a fleet of vehicles).

In some aspects, various environments (e.g., cities, municipalities, and the like) may benefit disproportionally from fleet schedule shifting in comparison with the fleet, as the fleet operators may face additional business operation inconveniences from the fleet rescheduling. Accordingly, various embodiments of the disclosure may be used (e.g., using an analysis component 116) to determine quantified results representing the impact of re-scheduling on both the fleet and the environment, and generate information that may serve to help users achieve the best compromise for both entities. For example, a first user such as fleet operators may shift fleet schedules to realize social benefits to the city, for example, in terms of reduced traffic congestion, emission, and accidents. In return, a second user such as city governing entities may be able to provide incentives (e.g., parking privileges, discounts and the like) to the fleet to compensate for the fleet's additional business costs due to the re-scheduling. Such benefits may be facilitated by various embodiments of the disclosure, including, but not limited to, the information provided by the system, analytics insights generated by the system, the communication channel provided by the system, combinations thereof, and/or the like.

In one embodiment, the various components (e.g., a data component 110, a processing component 114, and an analysis component 116, and/or other components) can be connected either directly or via one or more networks. Such networks can include wired and wireless networks, including, but not limited to, a cellular network, a wide area network (WAN) (e.g., the Internet), or a local area network (LAN), non-limiting examples of which include cellular, WAN, wireless fidelity (Wi-Fi), Wi-Max, wireless LAN (WLAN), radio communication, microwave communication, satellite communication, optical communication, sonic communication, or any other suitable communication technology. Moreover, the aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components can be combined into a single component providing aggregate functionality. The components can also interact with one or more other components not specifically described herein for the sake of brevity, but known by those of skill in the art.

Further, some of the processes performed can be performed by specialized computers for carrying out defined tasks related to various types of neural networks in their particular context. The subject computer processing systems, methods apparatuses and/or computer program products can be employed to solve new problems that arise through advancements in technology, computer networks, the Internet and the like.

Embodiments of devices and systems (and their various components) described herein can employ artificial intelligence (AI) to facilitate automating one or more features described herein (e.g., generating routes and fleet schedules, generating various parameters related to the impact of the routes and fleet schedules, and the like). The components can employ various AI-based schemes for carrying out various embodiments/examples disclosed herein. To provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system, environment, etc. from a set of observations as captured via events and/or data. Determinations can be employed to identify a specific context or action, or can generate a probability distribution over states, for example. The determinations can be probabilistic—that is, the computation of a probability distribution over states of interest based on a consideration of data and events. Determinations can also refer to techniques employed for composing higher-level events from a set of events and/or data.

Such determinations can result in the construction of new events or actions from a set of observed events and/or stored event data, whether the events are correlated in close temporal proximity, and whether the events and data come from one or several event and data sources. Components disclosed herein can employ various classification explicitly trained (e.g., via training data) as well as implicitly trained (e.g., via observing behavior, preferences, historical information, receiving extrinsic information, etc.) schemes and/or systems (e.g., support vector machines, neural networks, expert systems, Bayesian belief networks, fuzzy logic, data fusion engines, etc.) in connection with performing automatic and/or determined action in connection with the claimed subject matter. Thus, classification schemes and/or systems can be used to automatically learn and perform a number of functions, actions, and/or determinations.

A classifier can map an input attribute vector, z=(z1, z2, z3, z4, . . . , zn), to a confidence that the input belongs to a class, as by f(z)=confidence(class). Such classification can employ a probabilistic and/or statistical-based analysis (e.g., factoring into the analysis utilities and costs) to determine an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence can be employed. Classification as used herein also is inclusive of statistical regression that is utilized to develop models of priority.

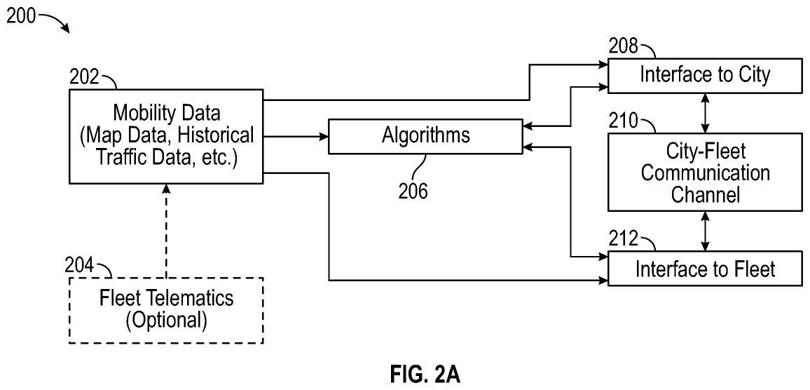

FIG. 2A shows a diagram of a platform framework, in accordance with example embodiments of the disclosure. In particular, FIG. 2A shows a platform 200 that may serve to host traffic-related data, run algorithms to generate analytical insights into traffic patterns for rescheduling, show the results to both the city and the fleet, and provide a communication channel between the city and the fleet. In particular, the mobility data 202 component may obtain and provide map data and historical traffic data. In another embodiment, additional data including fleet telematics data 204 may be optionally provided. In one embodiment, if fleet telematics data 204 is available, the fleet telematics data 204 can be fed into the mobility data 202 and one or more algorithms 206 (to be described further below) may be used to determine fleet trips and notify users of potential savings (e.g., cost savings, time savings, and the like) of re-scheduling. In another embodiment, if fleet telematics data 204 are not available, the platform 200 may nevertheless be useful for fleets that input routes to the system through a separate web or software interface. In another embodiment, fleet telematics data 204 can also be used as evidence that the fleet is operating under the schedule and contributing to claimed social benefits, and the city government can use the telematics data 204 to monitor the impact of fleet re-scheduling.

In various embodiments, algorithms 206 may use the mobility data 202 and/or the fleet telematics data 204 to quantify the impact on various metrics including, but not limited to, economic, social and environmental metrics to the city and the fleet; the algorithms 206 may generate suggested re-scheduling options. In some embodiments, the algorithms 206 may not provide a single optimal plan, since trade-off among these metrics may be complex. Instead, the algorithms 206 may output the quantified cost and metrics for various feasible re-schedule times, and defer to the users (e.g., the city and fleet operators) to select a given re-schedule time.

In another embodiment, the interface to the city 208 and the interface to the fleet 212 may include algorithm outputs that may be shown to users (e.g., city and the fleet operators) through an interface, including, but not limited to, a software user interface, one or more webpages, mobile apps, combinations thereof, and/or the like.

In one embodiment, the city-fleet communication channel 210 may include a means of facilitating user (e.g., city and fleet operator) cooperation, for example, based on the algorithms' 206 outputs. In another embodiment, the city-fleet communication channel 210 may allow the city to provide proper incentives (funding, parking privileges, combinations thereof, and/or the like) to fleet operators and users to re-schedule operation. For example, this may be due to the fact that the analytics results indicate that one user (e.g., the city) may obtain more benefit than another user (e.g., the fleet).

In various embodiments, the city-fleet communication channel 210 may be implemented in multiple ways. In particular, one user (e.g., the city) may broadcast one or more general policies using the city-fleet communication channel 210. The other user (e.g., the fleet) may submit route and re-schedule proposals using the city-fleet communication channel 210 and may provide feedback to the first user. It may also be possible for the city and the fleet to negotiate over the city-fleet communication channel 210 based on the data (e.g., mobility data 202 and/or the fleet telematics data 204) and various analytics results for better cooperation. The city-fleet communication channel 210 can also be expanded to serve other general city-fleet communication needs.

FIG. 2B shows a diagram of an algorithm workflow, in accordance with example embodiments of the disclosure. In various embodiments, the time 222 input of diagram 201 may include a variable that needs to be optimized. In various embodiments, the cost and metrics (e.g., labor time cost for fleet 250, energy cost and safety metrics for fleet 252, energy, CO₂ output, emission and safety metrics for city 254, and/or congestion metrics for city 256) of diagram 201 may be related to one or more factors (e.g., factors including, but not limited to, economics, environment, social benefits and politics, and the like), and the users (e.g., fleet and city operators) may be able to trade scheduling times and related benefits internally for optimizing their individual benefits. Accordingly, the algorithms shown in diagram 201 may not provide a single optimal time 222. Instead, the algorithms may determine a quantified cost and metrics for different feasible times, and may permit the users (e.g., the city and fleet operators) to find a solution that works for them. The cost and metrics (e.g., labor time cost for fleet 250, energy cost and safety metrics for fleet 252, energy, CO₂, emission and safety metrics for city 254, and/or congestion metrics for city 256) on the right of the diagram 201 can include absolute values (e.g., the total energy consumption), or may include relative values (e.g., the travel time saved if the fleet were to be scheduled one hour earlier than its normal hour of operation).

In various embodiments, the algorithms A1 232, A2 234, A3 242, A4 244, A5 246, and A6 248 are further described below. In another embodiment, time 222 may refer to the start time for a fleet trip and may serve as a variable to be optimized by the algorithms. In another embodiment, different times may be determined and used by the various algorithm (to be discussed) in order to calculate the metrics for users (e.g., the city and fleet) under different re-scheduled operations.

In one embodiment, historical traffic data 224 may refer to average vehicle speed data on various road segments at different times (e.g., historical data). The historical traffic data 224 may be purchased from third-party vendors, or may be generated, for example, using vehicle telematics data.

In another embodiment, the fleet route 226 may refer to route information determined from fleet telematics global positioning system (GPS) data, or may refer to a proposed route input by a user (e.g., a fleet manager) through a system interface. In various embodiments, fleet telematics GPS data may be in the form of longitude and latitude coordinate information including noise. In another embodiment, any suitable map-matching algorithm may be used to convert the fleet telematics GPS data into a sequence of road segments on a map. In one embodiment, the traffic speed of road segments 228 may include historical traffic data on road segments at different times along with a timestamp; further, the traffic speed of road segments at the time of travel may be obtained.

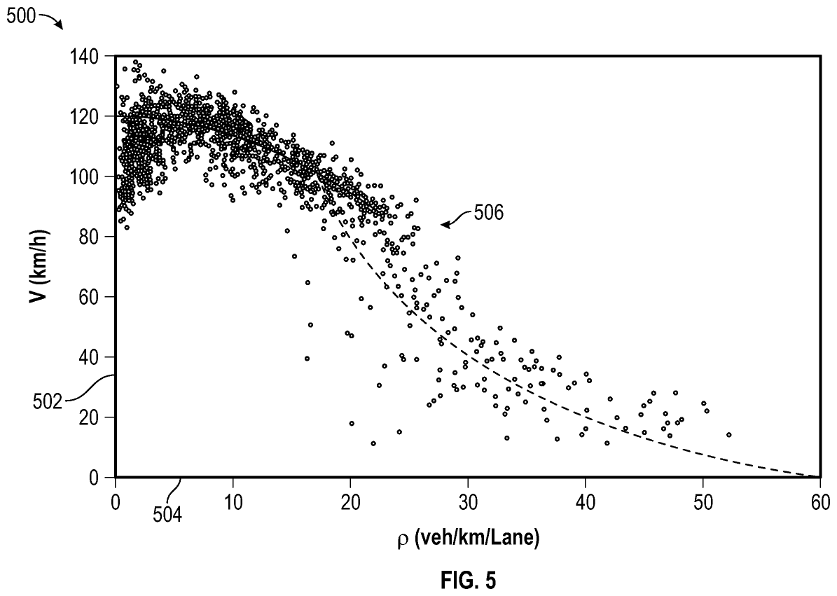

In one embodiment, the speed-density diagram 230 of road segments may refer to the attribute of a road segment, independent of traffic conditions. In another embodiment, the higher the traffic density, the slower the traffic speed may be. Before the road starts to become congested, the speed can remain almost the same as the free-flow speed. After a certain point, the traffic speed may start to decrease significantly as the density increases. An example speed-density diagram 230 is shown and described in connection with FIG. 5, below. Further, the speed-density diagrams 230 may vary slightly for different roads. In another embodiment, the speed-density diagrams 230 data may be obtained for individual roads. However, if the data for such individual road is not available, a speed-density diagram, which may be saturated at the speed limit or free-flow speed of the specific road segment, may be used to approximate the speed-density diagram 230.

In one embodiment, a single vehicle travel time 238 may refer to the travel time on the given route when a vehicle starts a trip at a given time. In another embodiment, the marginal social travel time 240 may refer to the additional travel time for other vehicles in a given environment due to one vehicle's existence on a road. In another embodiment, the marginal social travel time 240 may represent the link between a micro-view (e.g., a single-vehicle-level behavior) change and a macro-view change (e.g., the city-level impact). As shown in the speed-density diagram of FIG. 5, below, when one more vehicle is added to the road, the road traffic density may increase, and the average traffic speed may decrease, unless the traffic is still free flowing. In another embodiment, the speed decrease may cost other vehicles on the road additional travel time. Then this additional travel time can be correlated to various cost metrics such as the total energy consumption, emission, and accident rate, and the like. In particular, algorithm A2 234 may be used to calculate the total additional travel time for other vehicles on the road, using available mobility data, without requiring extra sensors or road infrastructure support.

In one embodiment, the labor time cost for a fleet 250 may refer to a quantified labor time cost associated with driving and traveling. In another embodiment, the energy cost and safety metrics for a fleet 252 may refer to a quantified measure for fuel and/or electricity cost, and a risk of accidents for the vehicle traveling at the given time on the given route. In a further aspect, the energy, CO₂, emission and safety metrics for city 254 may refer to a quantified measure that describes the city-level change in fuel/electricity consumption, CO₂ emission, general emissions, and accidents. Further, the congestion metrics for city 256 may refer to a quantified measure for the city to evaluate if the road congestion level has changed.

In various embodiments, A1 232 includes an algorithm for single vehicle travel time estimation. This estimation can be done using any suitable estimated time of arrival (ETA) algorithms. In another embodiment, using historical traffic data, the estimation may include the sum of the travel time over the road segments plus time compensation in traffic light and turn locations.

In various embodiments, A2 234 includes an algorithm for marginal social travel time estimation. In particular, the marginal social travel time may refer to the additional travel time to other vehicles if one more vehicle is routed to the road. The derivation of the algorithm is explained in detail as follows. In an aspect, the total social travel time may be determined by first determining a single vehicle travel time. In particular, the single vehicle travel time over a road segment can be calculated as

t=L/V

where t may refer to the single vehicle travel time, V may refer to the average speed on the road segment, and L may refer to the road segment length.

In another embodiment, the traffic density and speed relationship may be as follows. When the road is congested, one more vehicle adding to the road may affect the travel time of other vehicles. One step to consider this impact is to find the relationship between the traffic density and the speed on the road segments. Further, the traffic speed-density diagram (e.g., see FIG. 5 and related description, below) of a road may have the following relationship,

V=f(ρ)

where ρ may refer to the per-lane traffic density. Moreover, f (⋅) may refer to a monotonically decreasing function, which means the more vehicles there are on the road, the slower the remaining vehicles may be. In an embodiment, this function can be slightly different for different types of roads and can be obtained from either traffic simulations or real-world data.

In one embodiment, on the single-lane road segments with length L and traffic density ρ, the total number of vehicles on this segment can be represented as

M=μL,

where M may refer to the number of vehicles.

In many cases, the real-time traffic density ρ may not be directly available. However, such values may be approximately estimated using the average speed data and the inverse function of f(ρ), as represented by

ρ=f⁻¹(V)

In one embodiment, the all-vehicle travel time may be determined. In particular, when the traffic density is a constant, all M vehicles may travel through the road edge of length L with the current traffic density ρ; accordingly, the total time of these affected vehicles may be calculated as

$$T = M t = \frac{ρ {L}^{2}}{f ( ρ )}$$

In one embodiment, the marginal social travel time may be determined as follows. First a perturbation on the traffic density and the impact on all-vehicle travel time may be determined. In particular, when there is a small change on the current traffic density ρ₀, the all-vehicle travel time will change too. The partial derivative below may describe this relationship as:

$$\frac{\partial T}{\partial ρ} {\vert}_{{ρ}_{0}} = \frac{\partial \frac{ρ {L}^{2}}{f ( ρ )}}{\partial ρ} {\vert}_{{ρ}_{0}} = \frac{{L}^{2}}{f ( {ρ}_{0} )} - \frac{{ρ}_{0} {f}^{′} ( {ρ}_{0} ) {L}^{2}}{{f}^{2} ( {ρ}_{0} )}$$

In another embodiment, the all-vehicle travel time change if one more vehicle is added to the road may be determined as follows. In particular, the number of all vehicles may be proportional to the traffic density. When one more vehicle is added to this road segment, the change of traffic density can be represented by

$$Δρ = \frac{Δ M}{L} = \frac{1}{L}$$

Accordingly, the all vehicle travel time change may be represented by

$$Δ T = Δ ρ \frac{\partial T}{\partial ρ} {\vert}_{{ρ}_{0}} = Δρ [ \frac{{L}^{2}}{f ( {ρ}_{0} )} - \frac{{L}^{2} {ρ}_{0} {f}^{′} ( {ρ}_{0} )}{{f}^{2} ( {ρ}_{0} )} ] = \frac{L}{f ( {ρ}_{0} )} - \frac{L {ρ}_{0} {f}^{′} ( {ρ}_{0} )}{{f}^{2} ( {ρ}_{0} )} = t - \frac{{ρ}_{0} {f}^{′} ( {ρ}_{0} )}{f ( {ρ}_{0} )} t$$

where ΔT may refer to the total travel time cost associated with a road edge on the road network graph. Further, the first term t in ΔT may refer to the single vehicle travel time, which may be approximately equal to the travel time of the added vehicle. The second term

$$- \frac{{ρ}_{0} {f}^{′} ( {ρ}_{0} )}{f ( {ρ}_{0} )} t$$

may refer to the time added to all other vehicles, which may be the marginal social travel time ΔT_{S}, represented by:

$$Δ {T}_{s} = - \frac{{ρ}_{0} {f}^{′} ( {ρ}_{0} )}{f ( {ρ}_{0} )} t$$

In one aspect, as f′(ρ₀) may always be non-positive, the marginal social travel time may always be non-negative.

In various embodiments, A3 242 represents an algorithm for labor time cost estimation. In particular, the labor time cost may be related to the vehicle travel time. Further, the actual cost for the fleet may be related to a work contract between users, total work hours and overtime hours, combinations thereof, and/or the like. In another embodiment, if the vehicle travel time is determined, various other parameters may be calculated using one or more customized estimators designed for an individual fleet.

In various embodiments, A4 244 may represent a statistical analysis technique and/or one or more machine learning algorithms for determining fleet energy cost and risk of accidents. In particular, A4 244 may include a technique that uses the statistical analysis or machine learning algorithms to correlate a single vehicle travel time change and an energy cost and/or a risk of accident change. In another embodiment, by using big data that describes mobility, a model can be built to describe metrics Mₑ (see below) using the fleet operational parameters including the travel time T_{f}, travel distance D_{f}, speed variation V_{std}, parameters to describe the road or region information R_{f}, combinations thereof, and/or the like. In particular, Mₑ may be given by

Mₑ=F_{f}(T_{f},D_{f},V_{std},R_{f}, . . . ),

where Mₑ may represent either the energy cost or risk of accidents, and F_{f} may represent the statistical model or the machine learning result.

In another embodiment, if the single vehicle travel time change, ΔT_{f}, is determined, then the change of metrics ΔMₑ can be approximated as

$$Δ {M}_{e} = \frac{\partial {F}_{f}}{\partial {T}_{f}} Δ {T}_{f} .$$

In various embodiments, A5 246 may represent an algorithm for statistical analysis or machine learning for determining city energy cost, CO₂ output, emission, and accidents. In particular, A5 246 may be similar to A4, in that the algorithm may use statistical analysis or machine learning algorithms to correlate the marginal social travel time with one or more of the city energy cost, CO₂, emission, and risk of accident change. With mobility big data, a model can be built to describe metrics M_{ec} using the city-level mobility parameters including the total travel time T_{c}, total travel distance D_{c}, speed variation V_{stdc}, parameters to describe the road or region information R_{c}, and other factors. In particular,

M_{ec}=F_{c}(T_{c},D_{c},V_{std},R_{c}, . . . ),

where M_{ec} can be either the energy cost, CO₂ output, emission, or risk of accidents, and F_{c} may represent the statistical model or machine learning algorithm.

In various embodiments, if the marginal social travel time change ΔT_{S} may be determined, then the change of metrics can be approximated as

$$Δ {M}_{ec} = \frac{\partial {M}_{ec}}{\partial {T}_{c}} Δ {T}_{s} ,$$

In various embodiments, A6 248 includes an algorithm for congestion estimation. In particular, the marginal social travel time change may be considered a relative measure of the city congestion level. Further, when the marginal social travel time decreases, vehicles may spend less time on the road, which may mean that the congestion level may be decreased and the traffic condition may be improved. Further, the difference in marginal social travel time may inform how much time may be saved for the public on travel.

In various aspects, embodiments of the disclosure are directed to schedule time optimization. In another embodiment, routes may be optimized in addition to the schedule time optimization, for example, by using any suitable route optimization technique.

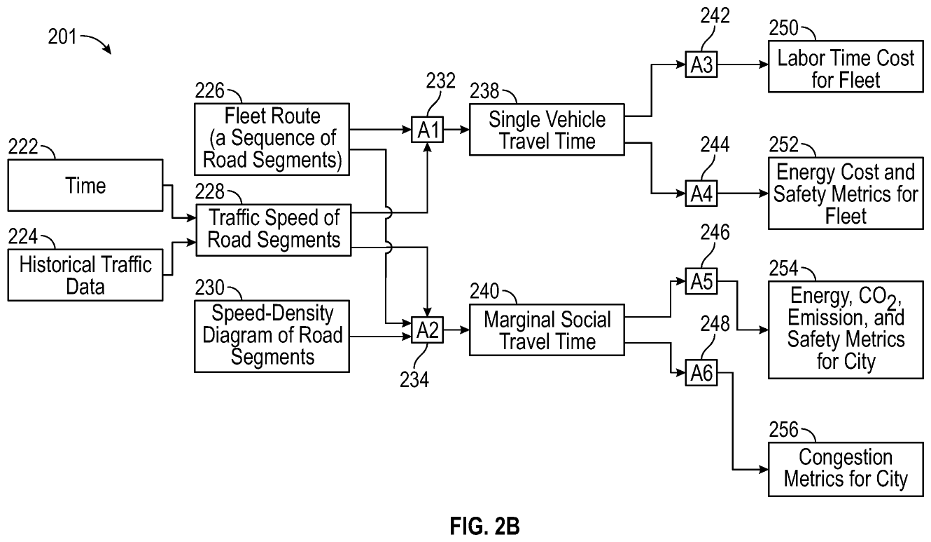

FIG. 3 provides a schematic of several computing entities that may be used to perform fleet scheduling and routing, according to one embodiment of the present disclosure. Further, the computing entities in FIG. 3 may be used in connection with one or more of the components shown and described in connection with FIGS. 1-2, above. In general, the terms computing entity, computer, entity, device, system, and/or similar words used herein interchangeably may refer to, for example, one or more computers, computing entities, desktop computers, mobile phones, tablets, phablets, notebooks, laptops, distributed systems, dongles, cameras, wristbands, wearable items/devices, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the system 300 may also include one or more communications interfaces 320 for communicating with various computing entities, such as by communicating data, content, information, and/or similar terms used herein interchangeably that can be transmitted, received, operated on, processed, displayed, stored, and/or the like. For instance, the system 300 may communicate with user devices and/or a variety of other computing entities.

As shown in FIG. 3, in one embodiment, the system 300 may include or be in communication with one or more processing elements 305 (also referred to as processors, processing circuitry, and/or similar terms used herein interchangeably) that communicate with other elements within the system 300 via a bus, for example. As will be understood, the processing element 305 may be embodied in a number of different ways. For example, the processing element 305 may be embodied as one or more complex programmable logic devices (CPLDs), microprocessors, multi-core processors, coprocessing entities, application-specific instruction-set processors (ASIPs), microcontrollers, and/or controllers. Further, the processing element 305 may be embodied as one or more other processing devices or circuitry. The term circuitry may refer to an entirely hardware embodiment or a combination of hardware and computer program products. Thus, the processing element 305 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 305 may be configured for a particular use or configured to execute instructions stored in volatile or non-volatile media or otherwise accessible to the processing element 305. As such, whether configured by hardware or computer program products, or by a combination thereof, the processing element 305 may be capable of performing steps or operations according to embodiments of the present disclosure when configured accordingly.

In one embodiment, the system 300 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 310, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the system 300 may further include or be in communication with volatile media (also referred to as volatile storage, memory, memory storage, memory circuitry and/or similar terms used herein interchangeably). In one embodiment, the volatile storage or memory may also include one or more volatile storage or memory media 315, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 305. Thus, the databases, database instances, database management systems, data, applications, programs, program modules, scripts, source code, object code, byte code, compiled code, interpreted code, machine code, executable instructions, and/or the like may be used to control certain aspects of the operation of the system 300 with the assistance of the processing element 305 and operating system.

As indicated, in one embodiment, the system 300 may also include one or more communications interfaces 320 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the system 300 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Zigbee, Bluetooth protocols, wireless universal serial bus (USB) protocols, and/or any other wireless protocol.

Although not shown, the system 300 may include or be in communication with one or more input elements, such as a keyboard input, a mouse input, a touch screen/display input, motion input, movement input, audio input, pointing device input, joystick input, keypad input, and/or the like. The system 300 may also include or be in communication with one or more output elements (not shown), such as audio output, video output, screen/display output, motion output, movement output, and/or the like.

As will be appreciated, one or more of the system 300 components may be located remotely from other system 300 components, such as in a distributed system. Furthermore, one or more of the components may be combined and additional components performing functions described herein may be included in the system 300. Thus, the system 300 can be adapted to accommodate a variety of needs and circumstances. As will be recognized, these architectures and descriptions are provided for example purposes only and are not limiting to the various embodiments.

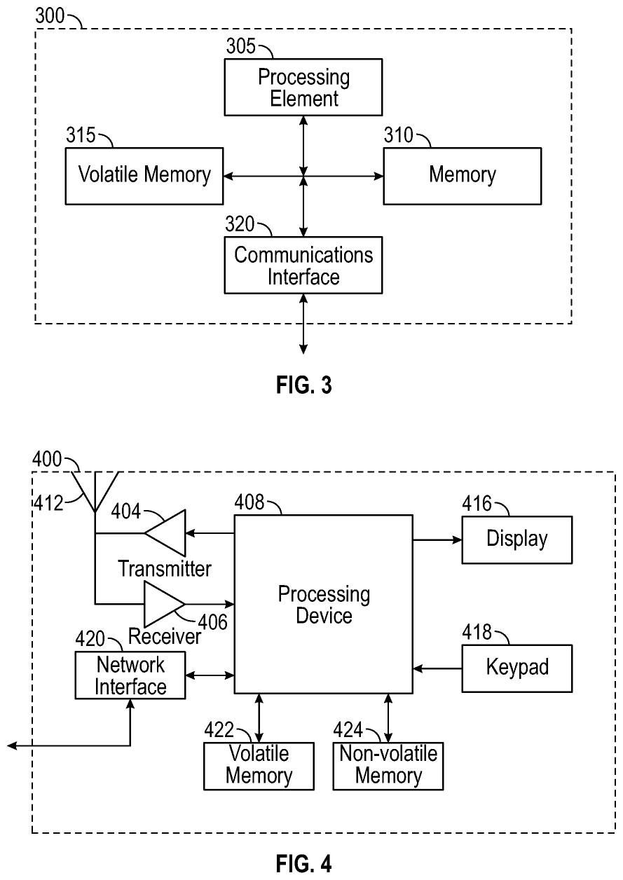

A user may be an individual, a family, a company, an organization, an entity, a department within an organization, a representative of an organization and/or person, and/or the like. In one example, users may be employees, residents, customers, and/or the like. For instance, a user may operate a user device (e.g., user device 400 shown and described in connection with FIG. 4, below) that includes one or more components that are functionally similar to those of the system 300.

FIG. 4 provides an illustrative schematic representative of a user device or other devices of the system that can be used in conjunction with embodiments of the present disclosure. In particular, such user devices and/or devices of the system may be used to determine traffic information, perform aspects of the AI-based algorithms described herein, display and collect feedback to users via the user devices, combinations thereof, and/or the like. In various embodiments, the algorithms described herein may be run at least partially on the user devices and may be in communication with centralized servers running algorithms and determining associated information. FIG. 4 provides an illustrative schematic representative of a user device 400 (e.g., a smart phone) or other devices of the system 300 (e.g., cameras, GPS receivers, ultrasonic receivers, microcontrollers, etc.) that can be used in conjunction with embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, gaming consoles (for example Xbox, Play Station, Wii), watches, glasses, key fobs, radio frequency identification (RFID) tags, ear pieces, scanners, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. User devices 400 can be operated by various parties. As shown in FIG. 4, the user device 400 or other devices of the system 300 (e.g., cameras, GPS receivers, ultrasonic receivers, microcontrollers, etc.) can include an antenna 412, a transmitter 404 (for example radio), a receiver 406 (for example radio), and a processing element 408 (for example CPLDs, microprocessors, multi-core processors, coprocessing entities, ASIPs, microcontrollers, and/or controllers) that provides signals to and receives signals from the transmitter 404 and receiver 406, respectively.

The signals provided to and received from the transmitter 404 and the receiver 406, respectively, may include signaling information in accordance with air interface standards of applicable wireless systems. In this regard, the user device 400 or other devices of the system 300 (e.g., cameras, GPS receivers, ultrasonic receivers, microcontrollers, etc.) may be capable of operating with one or more air interface standards, communication protocols, modulation types, and access types. More particularly, the user device 400 (e.g., a smart phone) or other devices of the system 300 (e.g., cameras, GPS receivers, ultrasonic receivers, microcontrollers, etc.) may operate in accordance with any of a number of wireless communication standards and protocols, such as those described above with regard to the system 300. In a particular embodiment, the user device 400 may operate in accordance with multiple wireless communication standards and protocols, such as UMTS, CDMA2000, 1×RTT, WCDMA, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the user device 400 may operate in accordance with multiple wired communication standards and protocols, such as those described above with regard to the system 300 via a network interface 420.

Via these communication standards and protocols, the user device 400 (e.g., a smart phone) or other devices of the system 300 (e.g., cameras, GPS receivers, ultrasonic receivers, microcontrollers, etc.) can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The user device 400 can also download changes, add-ons, and updates, for instance, to its firmware, software (for example including executable instructions, applications, program modules), and operating system.

According to one embodiment, the user device 400 (e.g., a smart phone) or other devices of the system 300 (e.g., cameras, GPS receivers, ultrasonic receivers, microcontrollers, etc.) may include location determining aspects, devices, modules, functionalities, and/or similar words used herein interchangeably. For example, the user device 400 (e.g., a smart phone) or other devices of the system 300 (e.g., cameras, GPS receivers, ultrasonic receivers, microcontrollers, etc.) may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites. The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. Alternatively, the location information can be determined by triangulating the user device's 400 position in connection with a variety of other systems, including cellular towers, Wi-Fi access points, and/or the like. Similarly, the user device 400 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (for example smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The user device 400 (e.g., a smart phone) or other devices of the system 300 (e.g., cameras, GPS receivers, ultrasonic receivers, microcontrollers, etc.) may also comprise a user interface (that can include a display 416 coupled to a processing element 408) and/or a user input interface (coupled to a processing element 408). For example, the user interface may be a user application, browser, user interface, and/or similar words used herein interchangeably executing on and/or accessible via the user device 400 to interact with and/or cause display of information from the system 300, as described herein. The user input interface can comprise any of a number of devices or interfaces allowing the user device 400 to receive data, such as a keypad 418 (hard or soft), a touch display, voice/speech or motion interfaces, or other input devices. In embodiments including a keypad 418, the keypad 418 can include (or cause display of) the conventional numeric (0-9) and related keys (#, *), and other keys used for operating the user device 400 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The user device 400 (e.g., a smart phone) or other devices of the system 300 (e.g., cameras, GPS receivers, ultrasonic receivers, microcontrollers, etc.) can also include volatile storage or memory 422 and/or non-volatile storage or memory 424, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the user device 400. As indicated, this may include a user application that is resident on the entity or accessible through a browser or other user interface for communicating with the system 300 and/or various other computing entities.

In another embodiment, the user device 400 (e.g., a smart phone) or other devices of the system 300 (e.g., cameras, GPS receivers, ultrasonic receivers, microcontrollers, etc.) may include one or more components or functionality that are the same or similar to those of the system 300, as described in greater detail above. As will be recognized, these architectures and descriptions are provided for example purposes only and are not limiting to the various embodiments.

FIG. 5 shows a plot of a speed-density diagram, in accordance with example embodiments of the disclosure. In particular, the speed-density diagram 500 may include a y-axis 502 that represents the velocity magnitude in units of kilometers per hour. Further, the speed-density diagram 500 may include an x-axis 504 that may represent the density of vehicles in units of vehicles per kilometer per lane. Further, the plot of the speed-density diagrams such as that of speed-density diagram 500 may vary slightly on different roads. In another embodiment, the data used in determining a speed-density diagram 500 may be obtained for individual roads in a given area. However, if the data for such individual road is not available, one speed-density diagram, saturated at the speed limit or free-flow speed of the specific road segment, may be used to approximate the actual speed-density diagram. In various embodiments, the data used to generate the speed-density diagram 500 may be obtained from one or more user devices (e.g., user device(s) 400 as shown and described in connection with FIG. 4, above).

As shown in the speed-density diagram 500 when one more vehicle is added to the road, the road traffic density may increase, and the average traffic speed may decrease, unless the traffic is free flowing. In another embodiment, the speed decrease may cost other vehicles on the road additional travel time. Further, this additional travel time can be correlated to various cost metrics including, but not limited to, the total energy consumption, emission, and accident rate, and the like, as variously described herein, for example, with respect to FIGS. 2A and 2B, above. In particular, algorithm A2 234 of FIG. 2B may be used to calculate the total additional travel time for other vehicles on the road, using available mobility data, without requiring extra sensors or road infrastructure support.

In various embodiments, the traffic speed-density diagram 500 of a road may represent the following mathematical relationship,

V=f(ρ)

where ρ may refer to the per-lane traffic density. Moreover, f(⋅) may refer to a monotonically decreasing function. Accordingly, the more vehicles there are on the road, the slower the remaining vehicles on the road may be. This function can be slightly different based on different types of roads and can be obtained from either traffic simulation or real-world data.

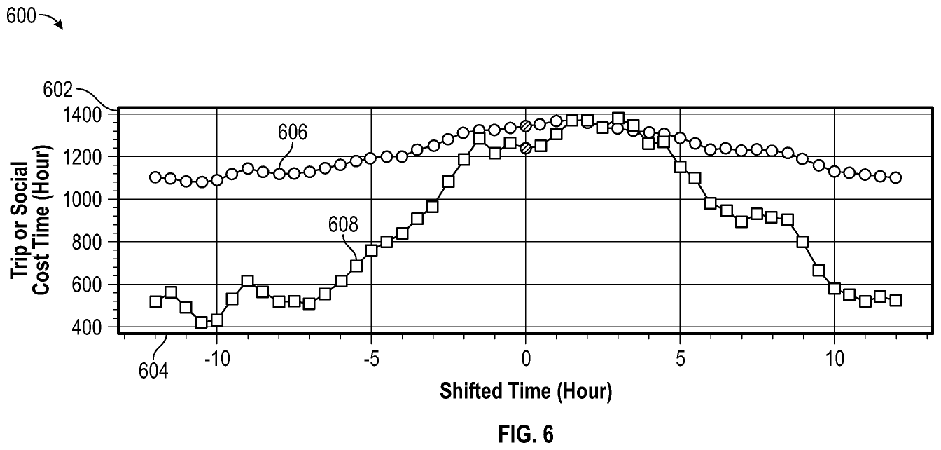

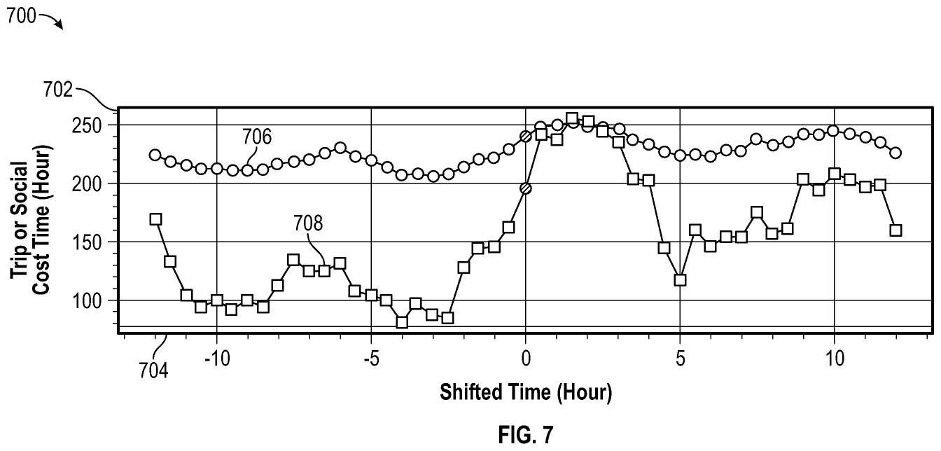

In the following description, example data and outputs are described and related to the diagrams of FIGS. 6 and 7, below. In particular, FIG. 6 shows a diagram of a plot representative travel time and marginal social travel time associated with and under various operation schedules, in accordance with example embodiments of the disclosure. An example of the platform application is provided which shows implementation results of A1 232 and A2 234 of FIG. 2, above. Further, an analysis using simplified A3 242 and A6 248 of FIG. 2 is provided.

In particular, algorithms A1 232 and A2 234 may be applied to data spanning a duration of one week for two different fleets running in urban areas. In one aspect, Fleet A may include 63 vehicles that may collectively travel about 23,000 km. Fleet B may include 16 vehicles that collectively travel about 7,000 km. In another embodiment, the two fleet operation characteristics may be different in terms of time and region. Further, data (e.g., fleet telematics data, third-party historical traffic data, etc.) may be used for the analysis.

In various embodiments, the fleet travel time 606 and marginal social travel cost time 608 of Fleet A under different operation schedules is shown in FIG. 6. In particular, the y-axis 602 may represent the trip travel time and marginal social travel time in units of hours, while the x axis 604 may represent the shifted time in units of hours, which may represent the relative schedule time change with respect to the actual operation hour that the fleet was running on.

FIG. 7 shows a diagram of another plot representative travel time and marginal social travel time associated with and under various operation schedules, in accordance with example embodiments of the disclosure. In various embodiments, the fleet travel time 706 and marginal social travel cost time 708 of Fleet B under different operation schedules is shown in FIG. 7. In particular, the y-axis 702 may represent the trip travel time and marginal social travel time in units of hours, while the x axis 704 may represent the shifted time in units of hours, which may represent the relative schedule time change with respect to the actual operation hour that the fleet was running on.

Diagram 600 of FIG. 6 and diagram 700 of FIG. 7 indicate that for both Fleets A and B, the city may obtain a larger time benefit (e.g., a greater reduction in marginal social time cost) from re-scheduling earlier than the fleet. In particular, for Fleet A, the benefit may be relatively small if the operation is shifted less than about 2 hours earlier, and the benefit may grow quickly if the schedule is shifted earlier for more than 2 hours. For Fleet B, the time benefit may be realized even if the shift is half an hour early (e.g., approximately 10 hours saved for the fleet, as compared with approximately 30 hours saved for the city). Accordingly, these results indicate that (1) the benefit of fleet re-scheduling may be complex and dependent on several variables complicated and may need to be analyzed case-by-case using mobility data, and (2) the city may obtain a relatively larger benefit than the fleet themselves. Therefore, it may be desirable to quantify the benefits to each user (e.g., city and fleet operators), and create a communication channel between the city and the fleet to facilitate the re-scheduling for better net benefits to both parties.

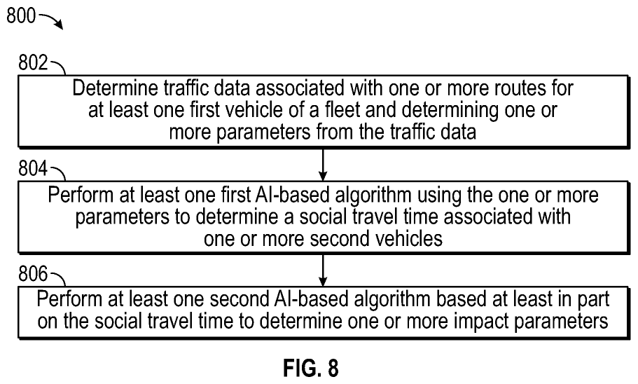

FIG. 8 shows a diagram of an example flow for implementing aspects of fleet management, in accordance with example embodiments of the disclosure. At block 802, the process 800 includes determining traffic data associated with one or more routes for at least one first vehicle of a fleet and determining one or more parameters from the traffic data. In another embodiment, the traffic data may be determined by a data component (e.g., data component 110 shown and described in connection with FIG. 1, above). Further, the traffic data further may include any suitable data including, but not limited to, road map data, historical traffic speed data, road speed-density data, fleet telematics data, traffic density data, emission data, and traffic accident data. The traffic data includes historical traffic data and near real-time traffic data.

At block 804, the process 800 includes performing at least one first AI-based algorithm using the one or more parameters to determine a social travel time associated with one or more second vehicles. In an embodiment, the first AI-based algorithm may be performed by a processing component (e.g., processing component 114 shown and described in connection with FIG. 1, above). Further, the at least one first AI-based algorithm may include one or more of a single-vehicle travel time estimator algorithm or a marginal social travel time estimator algorithm. In another embodiment, the one or more parameters may include at least one of a sequence of road segments, traffic speeds associated with the road segments, or a speed-density diagram associated with the road segments.

At block 806, the process 800 includes performing at least one second AI-based algorithm based at least in part on the social travel time to determine one or more impact parameters. Further, the one or more impact parameters may include one or more of a labor cost, an energy cost, or a safety metric. In another embodiment, the one or more impact parameters may include one or more of an energy cost, an emission cost, a safety metric, or a congestion for an environment associated with the fleet. In various embodiments, the second AI-based algorithm may be performed by the processing component described above, or may be performed by an analysis component (e.g., similar to analysis component 116 of FIG. 1, above). In another embodiment, the second AI-based algorithm may include one or more of a labor time cost estimation algorithm, a fleet energy cost and risk of accident assessment algorithm, a city energy cost estimation algorithm, an emission and accident assessment algorithm, or a congestion estimation algorithm. In one embodiment, determining the social travel time associated with the one or more second vehicles may include determining a marginal social travel time cost associated with the one or more second vehicles when one more vehicle is added to a route of the one or more routes. In further embodiments, information associated with the one or more parameters or the one or more impact parameters may be displayed to one or more users (e.g., city entities and/or fleet operations personnel).

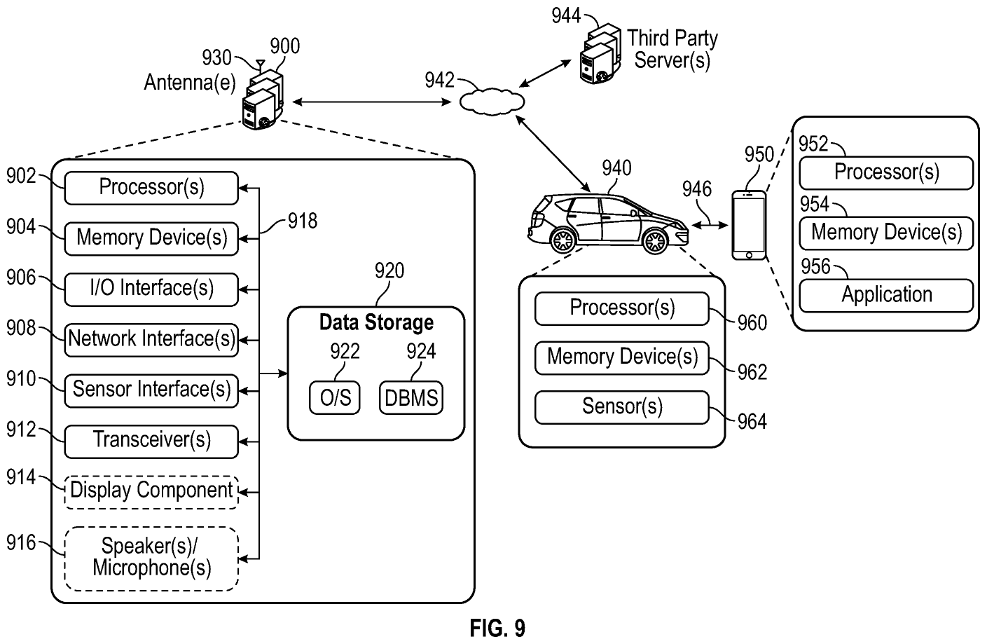

FIG. 9 is a schematic illustration of an example server architecture for one or more server(s) 900 in accordance with one or more embodiments of the disclosure. The server 900 illustrated in the example of FIG. 9 may correspond to a server that may be used by a vehicle on a network associated with the vehicle or a user device. Further, the server 900 may be used to perform any of the algorithms described herein, and may collect information from the various devices of the vehicle (e.g., vehicle 940), in order to implement any of the techniques described herein (e.g., AI-based algorithms for fleet management and scheduling). Further, the vehicle 940 may represent one vehicle of a fleet of vehicles, as variously described herein. In an embodiment, the server 900 may include a cloud-based server that may serve to store and transmit information. Some or all of the individual components may be optional and/or different in various embodiments. In some embodiments, at least one of the servers described in FIG. 9 may be located at an autonomous vehicle.

The server 900 may be in communication with a vehicle 940, one or more third party servers 944, and one or more user devices 950. The vehicle 940 may be in communication with the one or more user devices 950. Further, the server 900, the vehicle 940, the third party servers 944, and/or the user devices 950 may be configured to communicate via one or more networks 942. The vehicle 940 may additionally be in wireless communication with the user devices 950 via a connection protocol such as Bluetooth or Near Field Communication. Such network(s) 942 may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the server 900 may include one or more processors (processor(s)) 902, one or more memory devices 904 (also referred to herein as memory 904), one or more input/output (I/O) interface(s) 906, one or more network interface(s) 908, one or more sensor(s) or sensor interface(s) 910, one or more transceiver(s) 912, one or more optional display components 914, one or more optional speaker(s)/camera(s)/microphone(s) 916, and data storage 920. The server 900 may further include one or more bus(es) 918 that functionally couple various components of the server 900. The server 900 may further include one or more antenna(e) 930 that may include, without limitation, a cellular antenna for transmitting or receiving signals to/from a cellular network infrastructure, an antenna for transmitting or receiving Wi-Fi signals to/from an access point (AP), a Global Navigation Satellite System (GNSS) antenna for receiving GNSS signals from a GNSS satellite, a Bluetooth antenna for transmitting or receiving Bluetooth signals, a Near Field Communication (NFC) antenna for transmitting or receiving NFC signals, and so forth. These various components will be described in more detail hereinafter.

The bus(es) 918 may include at least one of a system bus, a memory bus, an address bus, or a message bus, and may permit the exchange of information (e.g., data (including computer-executable code), signaling, etc.) between various components of the server 900. The bus(es) 918 may include, without limitation, a memory bus or a memory controller, a peripheral bus, an accelerated graphics port, and so forth. The bus(es) 918 may be associated with any suitable bus architecture.

The memory 904 of the server 900 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

The data storage 920 may include removable storage and/or non-removable storage including, but not limited to, magnetic storage, optical disk storage, and/or tape storage. The data storage 920 may provide non-volatile storage of computer-executable instructions and other data.

The data storage 920 may store computer-executable code, instructions, or the like that may be loadable into the memory 904 and executable by the processor(s) 902 to cause the processor(s) 902 to perform or initiate various operations. The data storage 920 may additionally store data that may be copied to the memory 904 for use by the processor(s) 902 during the execution of the computer-executable instructions. More specifically, the data storage 920 may store one or more operating systems (O/S) 922; one or more database management systems (DBMS) 924; and one or more program module(s), applications, engines, computer-executable code, scripts, or the like. Some or all of these component(s) may be sub-component(s). Any of the components depicted as being stored in the data storage 920 may include any combination of software, firmware, and/or hardware. The software and/or firmware may include computer-executable code, instructions, or the like that may be loaded into the memory 904 for execution by one or more of the processor(s) 902. Any of the components depicted as being stored in the data storage 920 may support functionality described in reference to corresponding components named earlier in this disclosure.

The processor(s) 902 may be configured to access the memory 904 and execute the computer-executable instructions loaded therein. For example, the processor(s) 902 may be configured to execute the computer-executable instructions of the various program module(s), applications, engines, or the like of the server 900 to cause or facilitate various operations to be performed in accordance with one or more embodiments of the disclosure. The processor(s) 902 may include any suitable processing unit capable of accepting data as input, processing the input data in accordance with stored computer-executable instructions, and generating output data. The processor(s) 902 may include any type of suitable processing unit.

Referring now to other illustrative components depicted as being stored in the data storage 920, the O/S 922 may be loaded from the data storage 920 into the memory 904 and may provide an interface between other application software executing on the server 900 and the hardware resources of the server 900.

The DBMS 924 may be loaded into the memory 904 and may support functionality for accessing, retrieving, storing, and/or manipulating data stored in the memory 904 and/or data stored in the data storage 920. The DBMS 924 may use any of a variety of database models (e.g., relational model, object model, etc.) and may support any of a variety of query languages.

Referring now to other illustrative components of the server 900, the input/output (I/O) interface(s) 906 may facilitate the receipt of input information by the server 900 from one or more I/O devices as well as the output of information from the server 900 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. The I/O interface(s) 906 may also include a connection to one or more of the antenna(e) 930 to connect to one or more networks via a wireless local area network (WLAN) (such as Wi-Fi) radio, Bluetooth, ZigBee, and/or a wireless network radio, such as a radio capable of communication with a wireless communication network such as a Long Term Evolution (LTE) network, WiMAX network, 3G network, a ZigBee network, etc.

The server 900 may further include one or more network interface(s) 908 via which the server 900 may communicate with any of a variety of other systems, platforms, networks, devices, and so forth. The network interface(s) 908 may enable communication, for example, with one or more wireless routers, one or more host servers, one or more web servers, and the like via one or more networks.

The sensor(s)/sensor interface(s) 910 may include or may be capable of interfacing with any suitable type of sensing device such as, for example, inertial sensors, force sensors, thermal sensors, photocells, and so forth.

The display component(s) 914 may include one or more display layers, such as LED or LCD layers, touch screen layers, protective layers, and/or other layers. The optional camera(s) 916 may be any device configured to capture ambient light or images. The optional speaker(s)/microphone(s) 916 may be any device configured to receive analog sound input/output or voice data. The speaker(s)/microphone(s) 916 may include speakers and microphones used to capture or emit sound.

It should be appreciated that the program module(s), applications, computer-executable instructions, code, or the like depicted in FIG. 9 as being stored in the data storage 920 are merely illustrative and not exhaustive and that processing described as being supported by any particular module may alternatively be distributed across multiple module(s) or performed by a different module.

It should further be appreciated that the server 900 may include alternate and/or additional hardware, software, or firmware components beyond those described or depicted without departing from the scope of the disclosure.

The user device 950 may include one or more computer processor(s) 952, one or more memory devices 954, and one or more applications, such as an application 956. Other embodiments may include different components.

The processor(s) 952 may be configured to access the memory 954 and execute the computer-executable instructions loaded therein. For example, the processor(s) 952 may be configured to execute the computer-executable instructions of the various program module(s), applications, engines, or the like of the device to cause or facilitate various operations to be performed in accordance with one or more embodiments of the disclosure. The processor(s) 952 may include any suitable processing unit capable of accepting data as input, processing the input data in accordance with stored computer-executable instructions, and generating output data. The processor(s) 952 may include any type of suitable processing unit.

The memory 954 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

Referring now to functionality supported by the user device 950, the application 956 may be a mobile application executable by the processor 952 that can be used to present options and/or receive user inputs of information related to the disclosed embodiments. In addition, the user device 950 may communicate with the vehicle 940 via the network 942 and/or a direct connection, which may be a wireless or wired connection. The user device 950 may include a camera, scanner, bio reader or the like to capture biometric data of a user, perform a certain processing step on the biometric date, such as extracting features from captures biometric data, and then communicate those extracted features to one or more remote servers, such as one or more of cloud-based servers.

It should be appreciated that the program module(s), applications, computer-executable instructions, code, or the like depicted in FIG. 9 as being stored in the data storage 920 are merely illustrative and not exhaustive and that processing described as being supported by any particular module may alternatively be distributed across multiple module(s) or performed by a different module.

It should further be appreciated that the server 900 may include alternate and/or additional hardware, software, or firmware components beyond those described or depicted without departing from the scope of the disclosure.

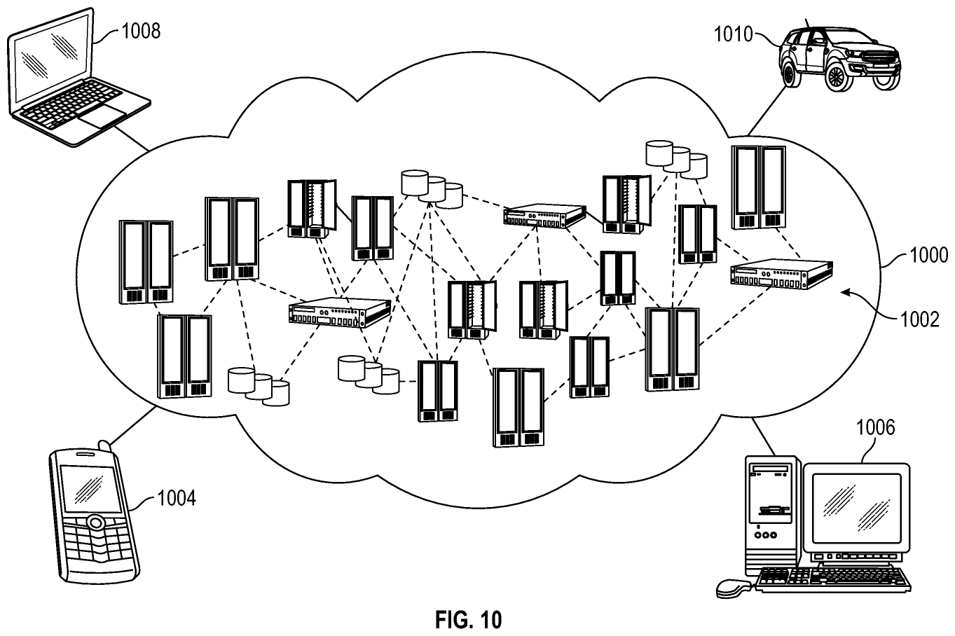

FIG. 10 shows a diagram of a cloud-computing environment that may be used in connection with example embodiments of the disclosure. As mentioned, one or more databases used in connection with the disclosure can include a database stored or hosted on a cloud computing platform. For example, the database may include the traffic data, telematics data, and the like, and may further be used to run one or more of the AI-based algorithms described herein. It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model can include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but can be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It can be managed by the organization or a third party and can exist on-premises or off-premises.

Community cloud: the cloud infrastructure is shared by several organizations and supports a specific community that has shared concerns (e.g., mission, security requirements, policy, and compliance considerations). It can be managed by the organizations or a third party and can exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 10, an illustrative cloud computing environment 1000 is depicted. Repetitive description of like elements employed in other embodiments described herein is omitted for sake of brevity. As shown, cloud computing environment 1000 includes one or more cloud computing nodes 1002 with which local computing devices used by cloud consumers, such as, for example, personal digital assistant (PDA) or cellular telephone 1004, desktop computer 1006, laptop computer 1008, and/or automobile computer system 1010 can communicate. Nodes 1002 can communicate with one another. They can be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1004-1010 shown in FIG. 10 are intended to be illustrative only and that computing nodes 1002 and cloud computing environment 1000 can communicate with any type of computerized device over any type of network and/or network addressable connection (e.g., using a web browser).

One or more operations of the methods, process flows, and use cases of FIGS. 1-10 may be performed by a device having the illustrative configurations depicted in FIGS. 9-10, or more specifically, by one or more engines, program module(s), applications, or the like executable on such a device. It should be appreciated, however, that such operations may be implemented in connection with numerous other device configurations.

The operations described and depicted in the illustrative methods and process flows and diagrams of FIGS. 1-10 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in and described in connection with FIGS. 1-10 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Example embodiments of the disclosure may include one or more of the following examples:

In example 1, a device is described, the device including: at least one memory comprising computer-executable instructions; and one or more computer processors configured to access the at least one memory and execute the computer-executable instructions to: determine traffic data associated with one or more routes for at least one first vehicle of a fleet and determine one or more parameters from the traffic data; perform at least one first artificial intelligence (AI)-based algorithm using the one or more parameters to determine a social travel time associated with one or more second vehicles; and perform at least one second AI-based algorithm based at least in part on the social travel time to determine one or more impact parameters.

In example 2, the traffic data may include road map data, historical traffic speed data, road speed-density data, fleet telematics data, traffic density data, emission data, and traffic accident data.

In example 3, the one or more impact parameters may include one or more of a labor cost, an energy cost, or a safety metric.

In example 4, the one or more impact parameters may include one or more of an energy cost, an emission cost, a safety metric, or a congestion for an environment associated with the fleet.

In example 5, the at least one first AI-based algorithm may include one or more of a single-vehicle travel time estimator algorithm or a marginal social travel time estimator algorithm.

In example 6, the at least one second AI-based algorithm may include one or more of a labor time cost estimation algorithm, a fleet energy cost and risk of accident assessment algorithm, a city energy cost estimation algorithm, an emission and accident assessment algorithm, or a congestion estimation algorithm.

In example 7, the one or more parameters may include at least one of a sequence of road segments, traffic speeds associated with the road segments, or a speed-density diagram associated with the road segments.

In example 8, the traffic data may include historical traffic data and near real-time traffic data.

In example 9, the one or more computer processors of example 1 may be configured to execute the computer-executable instructions to determine the social travel time associated with the one or more second vehicles further comprising computer-executable instructions to determine a marginal social travel time cost associated with the one or more second vehicles when one more vehicle is added to a route of the one or more routes.

In example 10, the one or more computer processors may be configured to execute the computer-executable instructions to cause to display information associated with the one or more parameters or the one or more impact parameters to one or more users.

In example 11, a method is described, the method including: determining traffic data associated with one or more routes for at least one first vehicle of a fleet and determining one or more parameters from the traffic data; performing at least one first AI-based algorithm using the one or more parameters to determine a social travel time associated with one or more second vehicles; and performing at least one second AI-based algorithm based at least in part on the social travel time to determine one or more impact parameters.

In example 12, the data may further include road map data, historical traffic speed data, road speed-density data, fleet telematics data, traffic density data, emission data, and traffic accident data.

In example 13, the one or more impact parameters may include one or more of a labor cost, an energy cost, or a safety metric.

In example 14, the one or more impact parameters may include one or more of an energy cost, an emission cost, a safety metric, or a congestion for an environment associated with the fleet.

In example 15, the at least one first AI-based algorithm may include one or more of a single-vehicle travel time estimator algorithm or a marginal social travel time estimator algorithm.

In example 16, a non-transitory computer-readable medium is described. The non-transitory computer-readable medium may store computer-executable instructions which, when executed by a processor, cause the processor to perform operations comprising: determining traffic data associated with one or more routes for at least one first vehicle of a fleet and determine one or more parameters from the traffic data; performing at least one first artificial intelligence (AI)-based algorithm using the one or more parameters to determine a social travel time associated with one or more second vehicles; and performing at least one second AI-based algorithm based at least in part on the social travel time to determine one or more impact parameters.

In example 17, the traffic data may further include road map data, historical traffic speed data, road speed-density data, fleet telematics data, traffic density data, emission data, and traffic accident data.

In example 18, the one or more impact parameters may include one or more of a labor cost, an energy cost, or a safety metric.

In example 19, the one or more impact parameters may include one or more of an energy cost, an emission cost, a safety metric, or a congestion for an environment associated with the fleet.

In example 20, the at least one first AI-based algorithm may include one or more of a single-vehicle travel time estimator algorithm or a marginal social travel time estimator algorithm.

What is claimed is:

1. A device, comprising:
at least one memory comprising computer-executable instructions; and
one or more computer processors configured to access the at least one memory and execute the computer-executable instructions to:
determine traffic data associated with one or more routes for at least one first vehicle of a fleet and determine one or more parameters from the traffic data;
perform at least one first artificial intelligence (AI)-based algorithm using the one or more parameters to determine a social travel time associated with one or more second vehicles; and
perform at least one second AI-based algorithm based at least in part on the social travel time to determine one or more impact parameters.

2. The device of claim 1, wherein the traffic data further comprises road map data, historical traffic speed data, road speed-density data, fleet telematics data, traffic density data, emission data, and traffic accident data.

3. The device of claim 1, wherein the one or more impact parameters comprise one or more of a labor cost, an energy cost, or a safety metric.

4. The device of claim 1, wherein the one or more impact parameters comprise one or more of an energy cost, an emission cost, a safety metric, or a congestion for an environment associated with the fleet.

5. The device of claim 1, wherein the at least one first AI-based algorithm comprises one or more of a single-vehicle travel time estimator algorithm or a marginal social travel time estimator algorithm.

6. The device of claim 1, wherein the at least one second AI-based algorithm comprises one or more of a labor time cost estimation algorithm, a fleet energy cost and risk of accident assessment algorithm, a city energy cost estimation algorithm, an emission and accident assessment algorithm, or a congestion estimation algorithm.

7. The device of claim 1, wherein the one or more parameters comprise at least one of a sequence of road segments, traffic speeds associated with the road segments, or a speed-density diagram associated with the road segments.

8. The device of claim 1, wherein the traffic data includes historical traffic data and near real-time traffic data.

9. The device of claim 1, wherein the one or more computer processors configured to execute the computer-executable instructions to determine the social travel time associated with the one or more second vehicles further comprise computer-executable instructions to determine a marginal social travel time cost associated with the one or more second vehicles when one more vehicle is added to a route of the one or more routes.

10. The device of claim 1, wherein the one or more computer processors are configured to execute the computer-executable instructions to cause to display information associated with the one or more parameters or the one or more impact parameters to one or more users.

11. A method comprising:
determining traffic data associated with one or more routes for at least one first vehicle of a fleet and determining one or more parameters from the traffic data;
performing at least one first AI-based algorithm using the one or more parameters to determine a social travel time associated with one or more second vehicles; and
performing at least one second AI-based algorithm based at least in part on the social travel time to determine one or more impact parameters.

12. The method of claim 11, wherein the traffic data further comprises road map data, historical traffic speed data, road speed-density data, fleet telematics data, traffic density data, emission data, and traffic accident data.

13. The method of claim 11, wherein the one or more impact parameters comprise one or more of a labor cost, an energy cost, or a safety metric.

14. The method of claim 11, wherein the one or more impact parameters comprise one or more of an energy cost, an emission cost, a safety metric, or a congestion for an environment associated with the fleet.

15. The method of claim 11, wherein the at least one first AI-based algorithm comprises one or more of a single-vehicle travel time estimator algorithm or a marginal social travel time estimator algorithm.

16. A non-transitory computer-readable medium storing computer-executable instructions which, when executed by a processor, cause the processor to perform operations comprising:
determining traffic data associated with one or more routes for at least one first vehicle of a fleet and determine one or more parameters from the traffic data;
performing at least one first artificial intelligence (AI)-based algorithm using the one or more parameters to determine a social travel time associated with one or more second vehicles; and
performing at least one second AI-based algorithm based at least in part on the social travel time to determine one or more impact parameters.

17. The non-transitory computer-readable medium of claim 16, wherein the traffic data further comprises road map data, historical traffic speed data, road speed-density data, fleet telematics data, traffic density data, emission data, and traffic accident data.

18. The non-transitory computer-readable medium of claim 16, wherein the one or more impact parameters comprise one or more of a labor cost, an energy cost, or a safety metric.

19. The non-transitory computer-readable medium of claim 16, wherein the one or more impact parameters comprise one or more of an energy cost, an emission cost, a safety metric, or a congestion for an environment associated with the fleet.

20. The non-transitory computer-readable medium of claim 16, wherein the at least one first AI-based algorithm comprises one or more of a single-vehicle travel time estimator algorithm or a marginal social travel time estimator algorithm.
